(19) United States
(12) Patent Application Publication
(10) Pub. No.: US 2019/0172094 A1
(43) Pub. Date: Jun. 6, 2019

(54) VISUAL DISPLAY SYSTEM AND METHOD

(71) Applicant: Ford Global Technologies, LLC, Dearborn, MI (US)

(72) Inventors: Andrew Murray, Colchester (GB); James Neugebauer, Chelmsford (GB); Richard Craven, Chelmsford (GB)

(73) Assignee: Ford Global Technologies, LLC, Dearborn, MI (US)

(21) Appl. No.: 16/206,887

(22) Filed: Nov. 30, 2018

(30) Foreign Application Priority Data
Dec. 1, 2017 (GB) 1720035.3

(51) Int. Cl. G06Q 30/02; G09F 21/04; G06F 3/14; G01C 21/34

(52) U.S. Cl. CPC G06Q 30/0266; G01C 21/34; G06F 3/1446; G09F 21/048

(57) ABSTRACT

A visual display system for a vehicle is provided. The visual display system comprising: at least one electronic display configured to produce an image visible from outside the vehicle; a controller for controlling an image displayed by the at least one electronic display; and an order fulfilment device, wherein the controller is configured to control the image displayed on the at least one electronic display based on input received from the order fulfilment device. A method of controlling a visual display is also provided.

### CROSS-REFERENCE TO RELATED APPLICATIONS

The present disclosure claims priority to and the benefit of GB application No. 1720035.3, filed Dec. 1, 2017, which is hereby incorporated by reference herein in its entirety.

### TECHNICAL FIELD

The present disclosure relates to a visual display system for a vehicle and is particularly, although not exclusively, concerned with a visual display system configured to improve the functionality of vehicle signage.

### BACKGROUND

When commercial vehicles such as vans are used by multiple operators (e.g. rental use, shared ownership) or to serve multiple clients/consignors (e.g. Uber RUSH, lifestyle couriers) traditional ‘permanent’ livery or signage on the exterior of the vehicle may be impractical or undesirable.

It is therefore desirable to provide a visual display system which can display context-relevant content.

### STATEMENTS OF INVENTION

According to an aspect of the present disclosure, there is provided a visual display system for a vehicle, the system comprising: at least one electronic display configured to produce an image visible from outside the vehicle; a controller for controlling the image displayed by the at least one electronic display; and an order fulfilment device, wherein the controller is configured to control the image displayed on the at least one electronic display based on input received from the order fulfilment device. The electronic display may be located on an exterior portion of the vehicle.

According to another aspect of the present disclosure, there is provided a visual display system for a vehicle, the system comprising: at least one electronic display located on an exterior portion of the vehicle; a controller for controlling an image displayed on the at least one electronic display; and an order fulfilment device, wherein the controller is configured to control the image displayed on the at least one electronic display based on input received from the order fulfilment device.

Input from the order fulfilment device may enable the electronic display to match a job currently being served or an expected delivery of an order to the vehicle. For example, if a van is set as the destination for a delivery (e.g. to receive parts/materials on site), the display may be activated by a courier to show an order number or client name in order to help distinguish the van from many similar vehicles which could be parked nearby. This feature has a technical benefit of enabling a consignee/consignor to recognise the vehicle at the time of delivery and therefore there is a greater chance of a successful delivery or job completion.

The order fulfilment device may be configured to provide the controller with input regarding an order to be fulfilled. The input may include information relating to a task to be executed by the vehicle in the context of fulfilling the order, such as a pick-up or drop-off.

The system may further comprise a navigation system capable of determining the location of the vehicle and providing the determined location to the controller.

The controller may be further configured to control the image displayed on the at least one electronic display based on the vehicle location. The vehicle location may be associated with an order to be fulfilled and therefore an image displayed on the at least one electronic display may be selected to be appropriate for display when fulfilling that order.

The order fulfilment device may further comprise a route planner in communication with the vehicle navigation system, the route planner being capable of optimizing a task execution route for multiple tasks. A task execution route is a route which may be travelled by the vehicle when fulfilling one or more tasks. For example, a task execution route may include pick-up and drop-off points relating to one or more orders to be fulfilled. Optimizing a task execution route may include any one of determining a fastest route, determining a shortest route and determining a route which results in more tasks being executed sooner (for example, where multiple pick-ups or drop-offs are located close together, these may be prioritised). In this context, a task may for example include a pick-up or a drop-off or both.

The controller may be further configured to control the image displayed on the at least one electronic display based on detection of a geo-fence. A geo-fence may be positioned around a specified area. A geo-fence may be a geographical barrier or threshold which is detectable by the controller, and, when the geo-fence is passed, the controller may control the image displayed on the at least one electronic display, for example to change the image. The threshold may be detectable by a separate detector in communication with the controller.

The system may further comprise a user input device and the controller may be further configured to control the image displayed on the at least one electronic display based on input received from the user input device.

The user input device is a mobile device capable of performing wireless communication with the controller.

The system may further comprise a remote management system capable of performing wireless communication with the controller.

The electronic display may comprise a liquid crystal display (LCD) screen, a light-emitting diode (LED) screen or a plasma technology screen.

The electronic display may comprise an e-ink or e-paper display.

According to another aspect of the present disclosure there is provided a vehicle comprising a visual display system as described above.

According to another aspect of the present disclosure there is provided a method of controlling a visual display on a vehicle, the method comprising: providing at least one electronic display on an exterior portion of the vehicle; providing means for controlling an image displayed on the at least one electronic display; providing an order fulfilment device; and controlling the image that is displayed on the at least one electronic display based on input received from the order fulfilment device.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention. For example, features described in relation to the second aspect described above, may apply to the other aspects described above.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a block diagram of a visual display system according to an arrangement;

FIG. 2 shows exemplary images on a display according to an arrangement; and

FIG. 3 shows a block diagram of a visual display system according to another arrangement.

### DETAILED DESCRIPTION

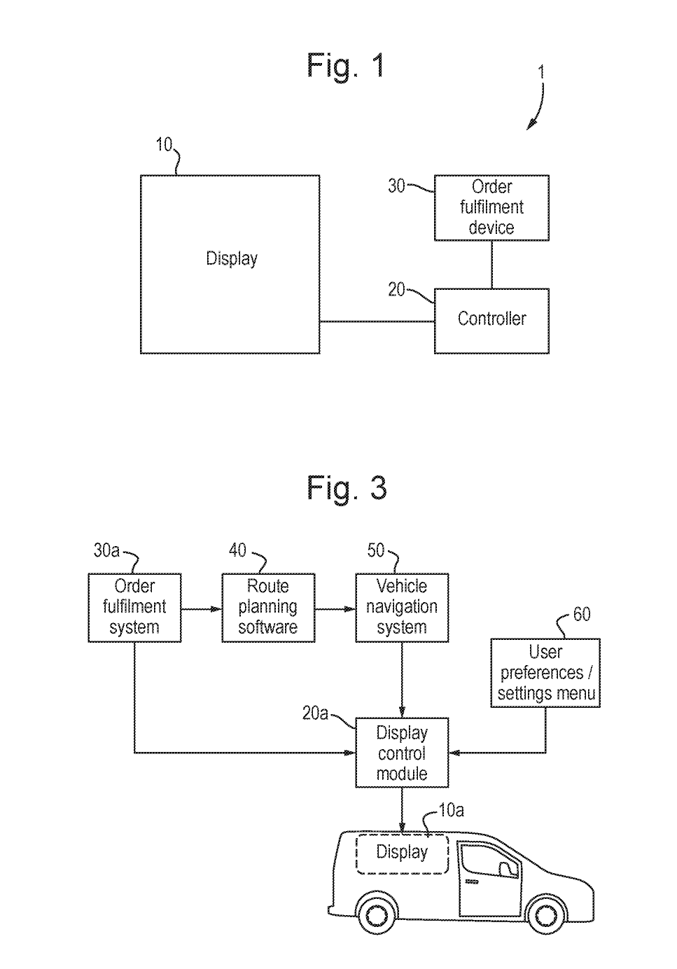

With reference to FIG. 1, a visual display system 1 for a motor vehicle comprises an electronic display (display) 10, a controller 20 and an order fulfilment device (order fulfilment system) 30. In the arrangement depicted in FIG. 1, the controller 20 is configured to control an image displayed on the electronic display 10. The visual display system 1 may, according to an arrangement, be fitted to a vehicle, such as a commercial vehicle, a van or similar. The electronic display 10 may be located on an exterior portion of the vehicle. For example, the electronic display 10 may be attached to or integrated with the sides or the rear of the vehicle to enable logos, graphics and/or text to be displayed. Alternatively, the electronic display 10 may be installed within the interior of the vehicle. For example, the electronic display 10 may be attached to or integrated with an interior trim portion of the vehicle, such as a seat, door panel, ceiling panel, centre console or dashboard of the vehicle.

The electronic display 10, e.g. the image being displayed by the electronic display, may be visible from outside of the vehicle. The electronic display 10 may comprise a display screen and the electronic display 10, e.g. the display screen of the electronic device, may be visible from outside the vehicle. Alternatively, the electronic display 10 may comprise an image projector configured to project an image that is visible from outside the vehicle. For example, the electronic display 10 may be configured to project the image onto a window of the vehicle, or a panel or trim portion of the vehicle.

The order fulfilment device 30 may be any device used to accept an incoming job and/or to designate a vehicle as being used for a specific job. The order fulfilment device 30 may store details of a company for which the order is being carried out (who commissioned the job), to whom or to where a delivery is being made and what the order is, for example if the goods are high value or delivery is urgent.

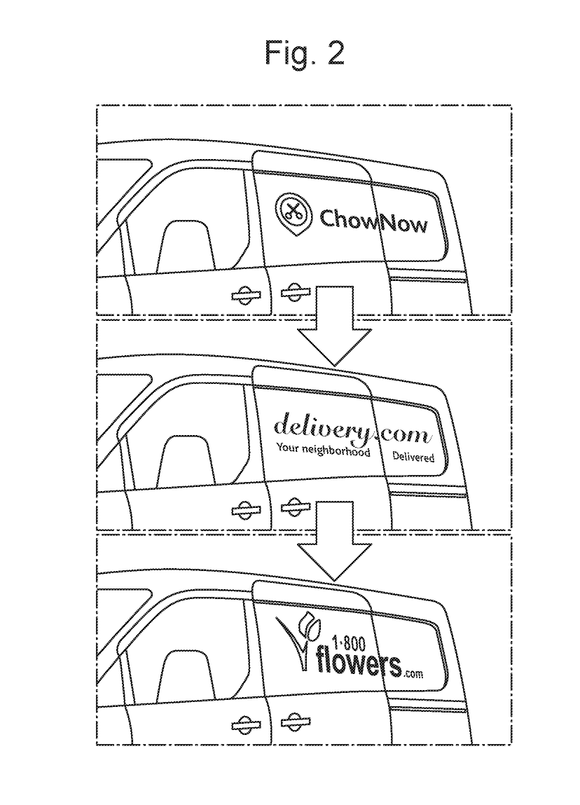

In an arrangement, the image displayed on the electronic display 10 relates to a current job for which the vehicle is being used. FIG. 2 shows exemplary images which may be displayed on the electronic display 10. In the arrangement of FIG. 2 company logos or contact details are displayed on the side of a van. The image displayed is changed in dependence on the job being carried out. In the exemplary images depicted in FIG. 2, the electronic display 10 initially displays “ChowNow”, then “delivery.com” and finally “1-800flowers.com”. Therefore, in the arrangement shown, the vehicle is used initially to perform a job for ChowNow. Subsequently, a job is performed for delivery.com. The final job is then performed for 1-800flowers.com, in this example. The electronic display 10 may be updated automatically once a job is complete and/or another job is accepted.

In the arrangement, according to FIG. 1, the visual display system 1 comprises one electronic display 10. However, the visual display system 1 may comprise two or more electronic displays 10. For example, a vehicle may include one electronic display 10 on, or visible from either side of the vehicle and one on, or visible from the rear of the vehicle. In the arrangement shown in FIG. 1, the electronic display 10 is attached to an outward facing surface of the vehicle such that an image displayed on the electronic display 10 may be seen by members of the public who are outside or near the vehicle. In other arrangements, the electronic display 10 may be configured to project the image onto the outward facing surface or otherwise produce the image such that it is visible from outside or near the vehicle. The controller 20 may be any suitable controller operable to control one or more electronic displays 10.

In an arrangement, the order fulfilment device 30 may be configured to provide the controller 20 with input regarding a task to be executed by the vehicle. For example the order fulfilment device 30 may provide the controller 20 with information relating to the company for which the order is to be performed or information indicating the intended appearance of the vehicle while carrying out the job such that an appropriate image can be displayed on the electronic display 10.

With reference to FIG. 3, in an arrangement, there is provided a display (electronic display) 10a, a display control module (controller) 20a, an order fulfilment system (order fulfilment device) 30a, route planning software (route planner) 40, a vehicle navigation system (navigation system) 50 and a user preferences/setting means (user input device) 60. It is to be understood that insofar as it is technically possible one or more of these features may be combined with the features of other embodiments in isolation from the others shown in this arrangement.

As shown in FIG. 3, a display 10a may be located on the side of a commercial vehicle, in this case a van. The display control module 20a may control the image displayed on the display 10a. The order fulfilment system 30a may store information relating to orders which are to be fulfilled through use of the vehicle. The order fulfilment system 30a may provide information to the route planning software 40 of, for example, the pick-up and drop-off points relating to a particular order. The route planning software 40 may use this information to determine an optimised route for one or more pick-up and/or drop-off and may be programmed to show preference to certain routes or towards avoiding certain locations (e.g. traffic hotspots). The route planning software 40 may provide the determined optimised route to the vehicle navigation system 50. The vehicle navigation system 50 may guide the driver to the next drop-off or pick-up point. During navigation, the vehicle navigation system 50 may determine whether the vehicle crosses a geo-fence and may automatically change the image displayed on the display 10a. The vehicle navigation system 50 may inform the driver that the image has been changed. The vehicle navigation system 50 may further be used to determine when the display 10a should be turned off such that no image is displayed. For example, this may be appropriate when the vehicle is no longer in use or is no longer in commercial use. The user preferences/setting menu 60 may be located with a separate entity and/or at a separate location such that displays on multiple vehicles may be controlled from a single location.

The vehicle navigation system 50 may be capable of locating the vehicle on any suitable mapping or coordinate system. The vehicle navigation system 50 may use GPS and may include a display to display an image appropriate for the location of the vehicle. The vehicle navigation system 50 may guide the driver to an appropriate pick-up or drop-off point. In an arrangement the display control module 20a is configured to control the image displayed on the display 10a based on the location of the vehicle.

In an arrangement the display control module 20a is configured to control the image displayed on the display 10a based on detection of a geo-fence. A geo-fence may be any suitable form of geographic boundary, representative boundary or virtual boundary and may be set based on the instructed jobs or based on user input. The geo-fence may set a particular territory or area, wherein when the vehicle is located within the area the display 10a may display an image associated with that area. For example, the vehicle may display an advertisement relevant to a local area, but when travelling outside that area may display an alternative image.

In an arrangement, the display control module 20a is configured to additionally control the image displayed on the display 10a based on input received from the user preferences/setting menu 60. For example, the driver of a vehicle may determine that the image displayed, while in the appropriate area or on the appropriate job, may no longer be suitable and therefore may wish to control the display 10a to display an alternative image. The user preferences/setting menu 60 may be a mobile device capable of wireless communication with the display control module 20a. For example, the mobile device may be located in the vehicle such that a user can change the image displayed on the display 10a from inside the vehicle.

In an arrangement, the visual display system 1 further comprises a remote management system capable of wireless communication with the display control module 20a. The remote management system may be capable of carrying out real-time updates and amending details of a job once already commenced. In an arrangement, the display 10a may comprise a liquid crystal display (LCD) screen, a light emitting diode (LED) screen or a plasma technology screen.

In an arrangement, the display 10a comprises an e-ink or e-paper technology display. An e-ink or e-paper display may for example not use its own backlight when displaying an image and instead may use reflection of the ambient light from the surrounding environment.

In an arrangement, a vehicle may include multiple displays 10a, wherein these multiple displays include at least one display such as an LED screen and another display such as an e-ink or e-paper display. In this arrangement it may be possible to reduce the energy consumption of the vehicle by switching to the e-ink or e-paper display at times of higher ambient light where back-lit displays are not required. A further benefit would be to use the e-ink or e-paper display when local legislation prohibits certain forms of light emission from moving vehicles.

The following additional, numbered statements of invention are also included within the specification and form part of the present disclosure:

Statement 1. A visual display system for a vehicle, the system comprising:
at least one electronic display configured to produce an image visible from outside the vehicle;
a controller for controlling the image displayed by the at least one electronic display; and
an order fulfilment device, wherein
the controller is configured to control the image displayed on the at least one electronic display based on input received from the order fulfilment device.
   Statement 2. The visual display system according to statement 1, wherein the electronic display is located on an exterior portion of the vehicle.
   Statement 3. A visual display system according to statement 1 or 2, wherein the order fulfilment device is configured to provide the controller with input regarding an order to be fulfilled.
   Statement 4. A visual display system according to any of statements 1 to 3, the system further comprising a navigation system capable of determining the location of the vehicle and providing the determined location to the controller.
   Statement 5. A visual display system according to statement 4, wherein the controller is further configured to control the image displayed by the at least one electronic display based on the vehicle location.
   Statement 6. A visual display system according to statement 4 or statement 5, wherein the order fulfilment device further comprises a route planner in communication with the vehicle navigation system, the route planner being capable of optimizing a task execution route for multiple tasks.
   Statement 7. A visual display system according to any preceding statement, wherein the controller is further configured to control the image displayed by the at least one electronic display based on detection of a geo-fence.
   Statement 8. A visual display system according to any preceding statement, the system further comprising a user input device; and wherein
the controller is further configured to control the image displayed by the at least one electronic display based on input received from the user input device.
   Statement 9. A visual display system according to statement 8, wherein the user input device is a mobile device capable of performing wireless communication with the controller.
   Statement 10. A visual display system according to any preceding statement, the system further comprising a remote management system capable of performing wireless communication with the controller.
   Statement 11. A visual display system according to any preceding statement, wherein the electronic display comprises a liquid crystal display (LCD) screen, a light-emitting diode (LED) screen or a plasma technology screen.
   Statement 12. A visual display system according to any preceding statement, wherein the electronic display comprises an e-ink or e-paper display.
   Statement 13. A vehicle comprising a visual display system according to any preceding statement.
   Statement 14. A method of controlling a visual display on a vehicle, the method comprising:
providing at least one electronic display such that an image produced by the electronic display is visible from outside the vehicle;
providing means for controlling an image displayed by the at least one electronic display;
providing an order fulfilment device; and
controlling the image that is displayed by the at least one electronic display based on input received from the order fulfilment device.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

I/We claim:

1. A visual display system for a vehicle, the system comprising:
at least one electronic display configured to produce an image visible from outside the vehicle;
a controller for controlling the image displayed by the at least one electronic display; and
an order fulfilment device, wherein
the controller is configured to control the image displayed on the at least one electronic display based on input received from the order fulfilment device.

2. The visual display system according to claim 1, wherein the electronic display is located on an exterior portion of the vehicle.

3. A visual display system according to claim 1, wherein the order fulfilment device is configured to provide the controller with input regarding an order to be fulfilled.

4. A visual display system according to claim 1, the system further comprising a navigation system capable of determining the location of the vehicle and providing the determined location to the controller.

5. A visual display system according to claim 4, wherein the controller is further configured to control the image displayed by the at least one electronic display based on the vehicle location.

6. A visual display system according to claim 4, wherein the order fulfilment device further comprises a route planner in communication with the vehicle navigation system, the route planner being capable of optimizing a task execution route for multiple tasks.

7. A visual display system according to claim 1, wherein the controller is further configured to control the image displayed by the at least one electronic display based on detection of a geo-fence.

8. A visual display system according to claim 1, the system further comprising a user input device; and wherein
the controller is further configured to control the image displayed by the at least one electronic display based on input received from the user input device.

9. A visual display system according to claim 8, wherein the user input device is a mobile device capable of performing wireless communication with the controller.

10. A visual display system according to claim 1, the system further comprising a remote management system capable of performing wireless communication with the controller.

11. A visual display system according to claim 1, wherein the electronic display comprises a liquid crystal display (LCD) screen, a light-emitting diode (LED) screen or a plasma technology screen.

12. A visual display system according to claim 1, wherein the electronic display comprises an e-ink or e-paper display.

13. A method of controlling a visual display on a vehicle, the method comprising:
providing at least one electronic display such that an image produced by the electronic display is visible from outside the vehicle;
providing means for controlling an image displayed by the at least one electronic display;
providing an order fulfilment device; and
controlling the image that is displayed by the at least one electronic display based on input received from the order fulfilment device.

14. A vehicle, comprising
a visual display system comprising:
at least one electronic display configured to produce an image visible from outside the vehicle;
a controller for controlling the image displayed by the at least one electronic display; and
an order fulfilment device, wherein
the controller is configured to control the image displayed on the at least one electronic display based on input received from the order fulfilment device.

15. The vehicle according to claim 14, wherein the electronic display is located on an exterior portion of the vehicle.

16. A vehicle according to claim 14, wherein the order fulfilment device is configured to provide the controller with input regarding an order to be fulfilled.

17. A vehicle according to claim 14, the system further comprising a navigation system capable of determining the location of the vehicle and providing the determined location to the controller.

18. A vehicle according to claim 17, wherein the controller is further configured to control the image displayed by the at least one electronic display based on the vehicle location.

19. A vehicle according to claim 17, wherein the order fulfilment device further comprises a route planner in communication with the vehicle navigation system, the route planner being capable of optimizing a task execution route for multiple tasks.

20. A vehicle according to claim 14, wherein the controller is further configured to control the image displayed by the at least one electronic display based on detection of a geo-fence.
